(19) United States
(12) Patent Application Publication
(10) Pub. No.: US 2017/0087939 A1
(43) Pub. Date: Mar. 30, 2017

(54) Vehicle Pneumatic Tyre

(71) Applicant: Continental Reifen Deutschland GmbH, Hannover (DE)

(72) Inventors: Michal Lacko, Puchov (SK); Matthias Gehlauf, Sehnde (DE); Fabian Wachmann, Hannover (DE)

(73) Assignee: Continental Reifen Deutschland GmbH, Hannover (DE)

(21) Appl. No.: 15/311,930

(22) PCT Filed: Feb. 13, 2015
(86) PCT No.: PCT/EP2015/053048

§ 371 Date: Nov. 17, 2016

(30) Foreign Application Priority Data
May 19, 2014 (DE) 10 2014 209 423.2

(51) Int. Cl. B60C 9/20

(52) U.S. Cl. CPC B60C 9/2006; B60C 2200/06; B60C 2009/2016; B60C 2009/2019

(57) ABSTRACT

Vehicle pneumatic tyre for utility vehicles having a carcass (5), having a belt (9) which is built up radially outside the carcass (5) and having a profiled tread (10) which is built up on the belt (9), radially outside the belt (9), wherein the belt (9) is formed from at least four belt layers (14, 17, 13, 15) arranged lying one on the other from radially on the inside to radially on the outside, wherein the first belt layer (14) which is arranged furthest on the inside in the radial direction R is embodied with parallel strength members (24) embedded in rubber, the second belt layer (17) which is arranged on the first belt layer (14) is embodied with parallel strength members (27) embedded in rubber, the third belt layer (13) arranged on the second belt layer (17) is embodied with parallel strength members (23) embedded in rubber, and the fourth belt layer (15) arranged on the third belt layer (13) is embodied with parallel strength members (25) embedded in rubber, characterized in that the third belt layer (13) and the fourth belt layer (15) are working layers in which the strength members (23) of the third belt layer (13) enclose in their orientation an angle α with respect to the circumferential direction U where 10°<α<45° and the strength members (25) of the fourth belt layer (15) enclose in their orientation in each case an angle γ with respect to the circumferential direction U where 10°<γ<45°, wherein, when viewed in the circumferential direction U of the vehicle tyre, the strength members (23) of the third belt layer (13) have an opposed axial direction of inclination to that of the strength members (25) of the fourth belt layer (15), in that the strength members (24) of the first belt layer (14) enclose in their orientation an angle β with respect to the circumferential direction U where 0°<β<5°, and the strength members (27) of the second belt layer (17) enclose in their orientation an angle ε with respect to the circumferential direction U where 40°<ε<75.

The invention relates to a pneumatic vehicle tire for utility vehicles, having a carcass, having a belt which is constructed radially outside the carcass and having a profiled tread which is constructed on the belt radially outside the belt, wherein the belt is formed from at least four belt plies arranged lying one on top of the other from the radial inside to the radial outside, wherein the first belt ply, which is arranged furthest to the inside in the radial direction R, is formed with parallel strength members embedded in rubber, the second belt ply, arranged on the first belt ply, is formed with parallel strength members embedded in rubber, the third belt ply, arranged on the second belt ply, is formed with parallel strength members embedded in rubber, and the fourth belt ply, arranged on the third belt ply, is formed with parallel strength members embedded in rubber.

Conventional pneumatic tires for utility vehicles usually have a four-ply belt with a so-called triangular configuration in which two working plies are arranged one on top of the other in a radial direction, the steel cords of which are each at an angle of approximately 15° to 30° with respect to the circumferential direction, wherein the steel cords of one working ply and those of the second working ply are inclined in different axial directions A. The working plies thereby form a cross-braced structure. In such belts there is usually a belt ply embodied as a barrier ply which is located under the working plies, the steel cords of which barrier ply are at an angle of 45° to 60° with respect to the circumferential direction, as a result of which the cords of the working plies and of the barrier ply form a triangular structure. This configuration with two working plies and barrier ply arranged underneath offers an option for initially optimizing the wear behavior. Furthermore, a migration of cracks from the lower working ply into the carcass is still possible to a small extent in spite of the barrier ply. In addition, an additional protective ply which forms the fourth belt ply is usually formed above the two working plies, the steel cords of which protective ply are also at an angle of approximately 15° to 30° with respect to the circumferential direction of the vehicle tire. However, such belts have a limited circumferential stiffness which can lead to excessive uneven wear of the tire.

It is also known to form pneumatic tires for utility vehicles with a four-ply arrangement with a radially inner barrier ply with steel cords which enclose an angle of approximately 45° to 65° with respect to the circumferential direction, with two working plies which are formed over the barrier ply and which, in a conventional way, form a cross-braced structure of their steel cords with an orientation of the steel cords of in each case approximately 15° to 30°, and with a fourth belt ply which is formed radially outside the two working plies on the outer working ply and which is embodied as a so-called zero degree ply, wherein the strength members thereof composed of steel cords are oriented substantially in the circumferential direction with an angle of 0° to 2.5° with respect to the circumferential direction. In such embodiments, the circumferential stiffness of the belt is increased, which has a positive effect on the durability of the belt. However, the inner working ply is formed with residual mobility. This can still unintentionally also adversely affect durability and wear. A migration of cracks from the lower working ply into the carcass is furthermore still also possible here to a small extent.

Furthermore, occasionally—for example in WO 2011/131383 A1—an embodiment of a pneumatic tire for a utility vehicle having a four-ply belt arrangement has been proposed, with a radially inner barrier ply with steel cords which enclose an angle of 50° with respect to the circumferential direction. Two working plies are formed radially outside the barrier ply. A 0°-ply is formed radially between the two working plies. In these embodiments, the two working plies are again formed in a cross-braced structure, and the steel cords thereof are oriented at angles of in each case 20° with respect to the circumferential direction. Such embodiments make it possible to realize a high circumferential strength and, in relation to a conventional pneumatic tire for utility vehicles, improved durability and an improved wear pattern. A migration of cracks from the lower working ply into the carcass is furthermore still also possible here to a small extent.

The invention is based on the object of providing a pneumatic vehicle tire for utility vehicles of said type, having at least four belt plies, in which, in a simple manner, and utilizing the advantages of the embodiment of a four-ply belt with two working plies and a barrier ply, additional protection against the migration of cracks from the lower working ply onto the carcass is made possible without additional outlay and at the same time the wear can be improved.

According to the invention, in the case of the embodiment of a pneumatic vehicle tire for utility vehicles, having a carcass, having a belt which is constructed radially outside the carcass and having a profiled tread which is constructed on the belt radially outside the belt, wherein the belt is formed from at least four belt plies arranged lying one on top of the other from the radial inside to the radial outside, wherein the first belt ply, which is arranged furthest to the inside in the radial direction R, is formed with parallel strength members embedded in rubber, the second belt ply, arranged on the first belt ply, is formed with parallel strength members embedded in rubber, the third belt ply, arranged on the second belt ply, is formed with parallel strength members embedded in rubber, and the fourth belt ply, arranged on the third belt ply, is formed with parallel strength members embedded in rubber, the object is achieved in accordance with the features of claim 1, wherein the third belt ply and the fourth belt ply are working plies, in which the strength members of the third belt ply enclose, in terms of their orientation, an angle α with the circumferential direction U, where 10°≦α≦45°, and the strength members of the fourth belt ply each enclose, in terms of their orientation, an angle γ with the circumferential direction U, where 10°≦γ≦45°, wherein, as viewed in the circumferential direction U of the vehicle tire, the strength members of the third belt ply have an opposite axial direction of inclination in relation to the strength members of the fourth belt ply, and wherein the strength members of the first belt ply enclose, in terms of their orientation, an angle β with the circumferential direction U, where 0°≦β≦5°, and the strength members of the second belt ply enclose, in terms of their orientation, an angle ε with the circumferential direction U, where 40°≦ε≦75°.

The embodiment makes it possible to maintain the embodiment with two working plies and an inner barrier ply arranged radially inside the working plies, which is advantageous with regard to good force transmission in the circumferential and lateral directions and with regard to low wear. The additional embodiment of the first belt ply arranged radially inside the barrier ply as zero degree ply brings about additional protection against the migration of cracks from the lower working ply into the carcass. Furthermore, the wear behavior can be further homogenized.

The embodiment of a pneumatic vehicle tire as per the features of claim 2 is particularly advantageous, wherein, as viewed in the circumferential direction U, the strength members of the third belt ply and the strength members of the second belt ply have the same axial direction of inclination. This permits further increased durability by minimizing the shear forces acting between the second and third belt plies and the controlled adjustment of the stiffness of the belt pack.

The embodiment of a pneumatic vehicle tire as per the features of claim 3 is particularly advantageous, wherein the third belt ply is formed so as to be larger, in terms of its axial extent in the pneumatic vehicle tire, than all of the other belt plies of the belt. This permits decoupling of the third and fourth belt plies, whereby the durability of the tire can be further improved.

The embodiment of a pneumatic vehicle tire as per the features of claim 4 is particularly advantageous, wherein the first belt ply is formed so as to be smaller, in terms of its axial extent in the pneumatic vehicle tire, than the third and the fourth belt ply and smaller than or equal to the axial extent of the second belt ply of the belt. This permits a uniform increase in strength from belt edge to belt center, further promoting good wear and long structural durability.

The embodiment of a pneumatic vehicle tire as per the features of claim 5 is particularly advantageous, wherein, radially inside the first belt ply, there is arranged a fifth belt ply with parallel strength members embedded in rubber, which strength members, in terms of their orientation, enclose an angle δ with the circumferential direction U of the pneumatic vehicle tire, where 40° <6 <75°—in particular where δ=50°—and wherein, as viewed in the circumferential direction U of the vehicle tire, the strength members of the fifth belt ply have an opposite axial direction of inclination relative to the strength members of the second belt ply. The embodiment permits an additional increase in the durability of the carcass in terms of reduction of the ply-steer effect and thus in terms of homogenizing the wear.

The embodiment of a pneumatic vehicle tire as per the features of claim 6 is particularly advantageous for achieving an improved wear pattern, wherein, as viewed in the circumferential direction U of the vehicle tire, the strength members of the fifth belt ply have the same axial direction of inclination relative to the strength members of the third belt ply. In this way, the occurrence of the ply-steer effect can be further counteracted and uniform wear promoted.

The embodiment of a pneumatic vehicle tire as per the features of claim 7 is particularly advantageous, wherein the fifth belt ply is formed so as to be smaller, in terms of its axial extent in the pneumatic vehicle tire, than the third belt ply and larger than or equal to the width of the first belt ply. In this way, a further improved wear pattern can be achieved by homogenized stiffness changes along the axial extent of the belt.

The embodiment of a pneumatic vehicle tire as per the features of claim 8 is particularly advantageous, wherein the strength members of the third belt ply and the strength members of the fourth belt ply are steel cords. In this way, durability and rolling resistance can be promoted. Furthermore, a high tensile strength and a high level of circumferential stiffness of the belt can be implemented in a cost-effective manner.

The embodiment of a pneumatic vehicle tire as per the features of claim 9 is particularly advantageous, wherein the strength members of the two working plies in the tire are designed to be extensible, with an elongation D of D≧0.2% at 10% of the breaking force. In this way, by way of flexibility of the belt pack, the durability of the tire can be further promoted. In this way, a low rolling resistance can be further promoted.

The embodiment of a pneumatic vehicle tire as per the features of claim 10 is particularly advantageous, wherein the strength members of the first belt ply are strength members composed of steel. In this way, a high level of circumferential stiffness and good durability and more uniform wear are further promoted. Furthermore, controlled tire growth is promoted. In this way, furthermore, a low rolling resistance of the tire and high flexural fatigue strength of the belt can be promoted.

The embodiment of a pneumatic vehicle tire as per the features of claim 11 is particularly advantageous, wherein the strength members of the first belt ply are steel cords which, at 10% of the breaking force, exhibit an elongation D of D≧0.2%—in particular of D≧1%. In this way, the elevation of the belt in the construction process can be made possible in a simple manner. In this way, a high level of circumferential stiffness and good durability and uniform wear are further promoted. In addition, controlled tire growth and footprint are promoted.

The embodiment of a pneumatic vehicle tire as per the features of claim 12 is particularly advantageous, wherein the strength members of the second belt ply are steel cords. In this way, a high level of stiffness of the belt and protection of the carcass against compression can be implemented in a simple manner, as a result of which the durability of the tire can be further promoted.

The embodiment of a pneumatic vehicle tire as per the features of claim 13 is particularly advantageous, wherein the strength members of the fifth belt ply are steel cords. In this way, durability and rolling resistance can be further promoted.

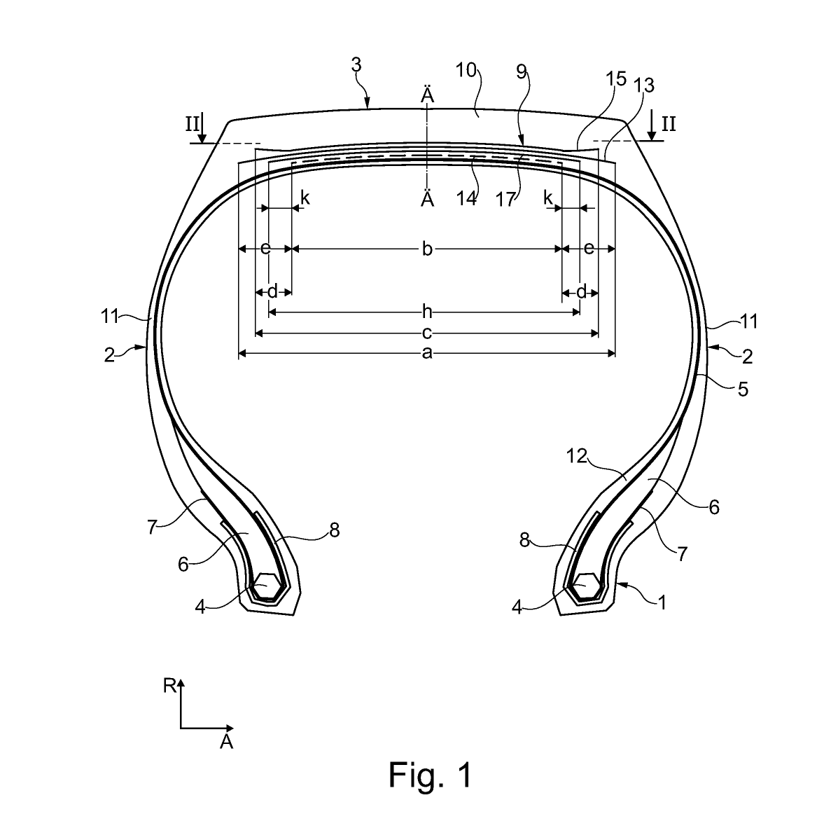

The invention will be discussed below on the basis of the exemplary embodiments of a pneumatic tire of radial type of construction for utility vehicles as illustrated in FIG. 1 to FIG. 4. In the figures:

FIG. 1 shows a cross-sectional illustration of a pneumatic vehicle tire of radial type of construction for utility vehicles,

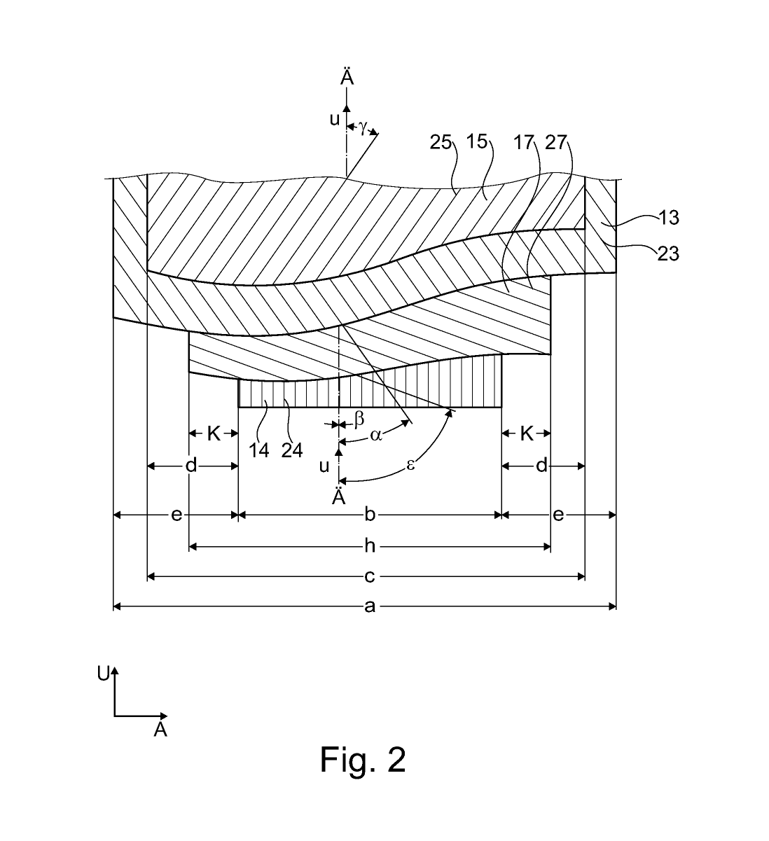

FIG. 2 shows a plan view of the belt from FIG. 1 as per the section II-II in FIG. 1, wherein for simplicity, all of the other components of the tire have not been illustrated,

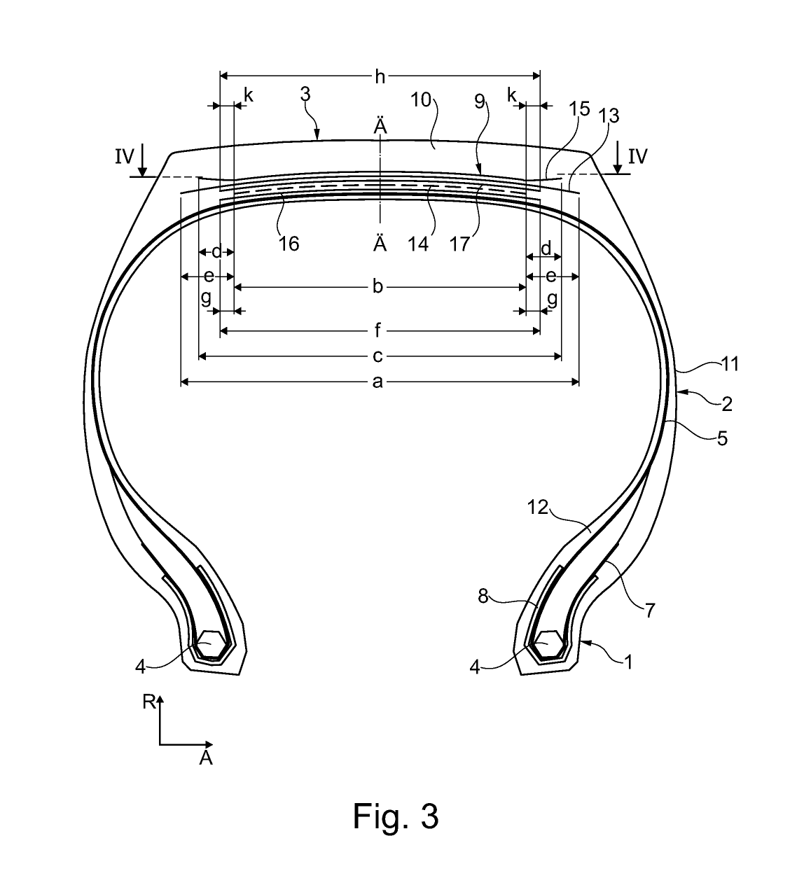

FIG. 3 shows a cross-sectional illustration of a pneumatic vehicle tire analogous to the illustration of FIG. 1, with an alternative belt embodiment,

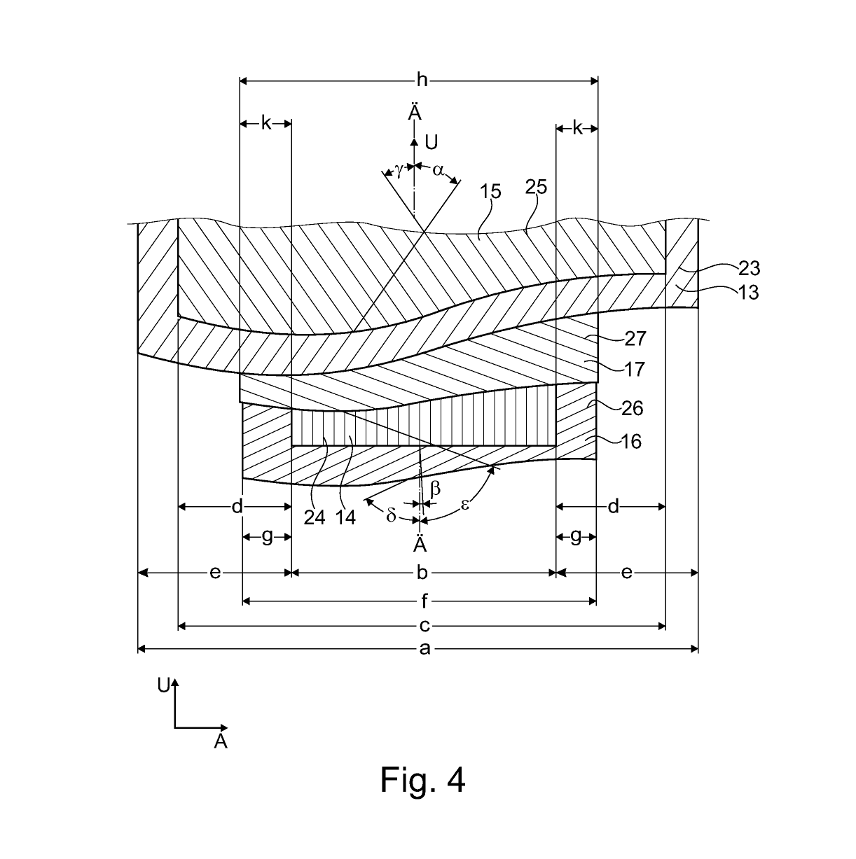

FIG. 4 shows a plan view of the belt from FIG. 3 as per the section IV-IV in FIG. 3, wherein for simplicity, all of the other components of the tire have not been illustrated.

FIG. 1 and FIG. 2 show a pneumatic tire of radial type of construction for utility vehicles, having two side walls 2 which extend in the radial direction R of the vehicle tire and having a crown region (top region) 3 which is formed axially between said side walls. The side walls are each formed with a bead region 1 on their extent end pointing inward in the radial direction, in which bead region there is formed a bead core 4 of known type, which has high tensile strength in the circumferential direction U and which extends over the circumference of the tire in the circumferential direction. The bead cores 4 are, in a known manner, formed in a wound manner from wire which extends in the circumferential direction U of the pneumatic vehicle tire and which is embedded in rubber. In the conventional manner, an apex (bead filler) 6 which is triangular in cross section is formed from a hard rubber material on the bead cores 4. The pneumatic vehicle tire is formed with a carcass 5 which, starting from the bead core 4 formed in the left-hand bead region 1 of the pneumatic vehicle tire, extends outward in the radial direction R of the pneumatic vehicle tire through the left-hand side wall 2 as far as the crown region 3, and in the crown region 3 extends in the axial direction A of the pneumatic vehicle tire to the right-hand side wall 2, and in the right-hand side wall 2 of the pneumatic vehicle tire extends radially inward as far as the bead core 4 formed in the bead region 1 of the right-hand side wall 2. The carcass is, in both core regions 1, formed so as to extend radially outward in each case along the axial inner side of the bead core 4 to the radial inner side of the respective bead core 4, then as an extension in the axial direction A along the radial inner side of the bead core 4 to the axial outer side of the bead core 4, and then as an extension on the axial outer side of the bead core 4, so as to constitute a turned-over part 7. The carcass 5 extends with its turned-over part 7 along the axial outer side of the apex 6 and ends on the axial outer side of the apex 6. The carcass 5 is formed, in a way which is known but not illustrated in more detail, from a carcass ply which extends in the circumferential direction U over the entire circumference of the pneumatic vehicle tire and which has parallel cords—for example steel cords—which are embedded in rubber and extend substantially in the radial direction R in the region of the side walls 2 and substantially in the axial direction A in the crown region. An inner layer 12 composed of known, particularly air-impermeable rubber material extends from the left-hand bead region 1 as far as the right-hand bead region 1 on that side of the carcass 5 which points toward the inside of the tire. An additional bead reinforcing strip 8, which extends over the entire circumference of the pneumatic vehicle tire, is respectively formed in the bead region 1 on that side of the carcass 5 which points away from the bead core 4. The bead reinforcing strip 8 is, for example, a material strip which is embedded in rubber and composed of parallel strength members of a textile or metallic design.

In the region of the tire crown (of the top of the tire) 3, a belt 9, which extends over the entire circumference of the pneumatic vehicle tire in the circumferential direction U and in the axial direction A from the left-hand tire shoulder as far as the right-hand tire shoulder, is formed on the carcass 5, outside the carcass 5 in the radial direction R of the pneumatic vehicle tire, which belt 9 is formed from four belt plies 14, 17, 13 and 15 which are arranged one above the other and so as to lie one on top of the other in the radial direction R from the inside to the outside. A profiled tread 10 of a known design, which extends over the entire circumference of the pneumatic vehicle tire in the circumferential direction U and in the axial direction A from the left-hand tire shoulder as far as the right-hand tire shoulder and which completely covers the belt 9, is formed on the belt 9 radially outside the belt 9. In the region of the tire side walls 2, a side wall rubber strip 11, which extends in the radial direction R from the bead region 1 as far as the profiled tread 10 in the crown region 3, is formed in a known manner on that side of the carcass 5 which points away axially from the tire.

That belt ply 14 of the belt which is arranged furthest to the inside in the radial direction R forms the first belt ply 14. That belt ply 17 which is arranged on the first belt ply 14, outside the first belt ply 14 in the radial direction R, forms the second belt ply 17. That belt ply 13 which is arranged on the second belt ply 17, outside the second belt ply 17 in the radial direction R, forms the third belt ply 13. That belt ply 15 which is arranged on the third belt ply 13, outside the third belt ply 13 in the radial direction R, forms the fourth belt ply 15.

The belt ply 13 and the belt ply 15 are embodied as working plies of the tire and extend in each case in the circumferential direction U over the entire circumference of the pneumatic vehicle tire and, in contact with one another, in the axial direction A from the left-hand tire shoulder as far as the right-hand tire shoulder. The working ply 13 is formed from a ply of filiform parallel strength members 23 which are embedded in rubber and which extend substantially rectilinearly over the entire width a, measured in the axial direction A, of the belt ply 13 and which enclose an angle of inclination α with respect to the circumferential direction U, where 10°≦α≦45°. The working ply 15 is formed from a ply of filiform parallel strength members 25 which are embedded in rubber and which extend substantially rectilinearly over the entire axial width c of the belt ply 15 and which enclose an angle of inclination γ with respect to the circumferential direction U, where 10°≦γ≦45°. The direction of inclination of the strength members 25 of the working plies 15 as viewed along the circumferential direction U is oriented in the opposite axial direction A in relation to the direction of inclination of the strength members 23 of the working ply 13.

The first belt ply 14, which is formed between the second belt ply 17 and carcass 5 in the radial direction R, extends in the circumferential direction U over the entire circumference of the pneumatic vehicle tire and in the axial direction A from the left-hand tire shoulder to the right-hand tire shoulder, and is embodied as a 0°-ply. For this purpose, the belt ply 14 is formed from parallel filiform strength members which are embedded in rubber and which extend linearly over the entire circumference of the pneumatic vehicle tire so as to enclose an angle β, where 0°≦β≦5°, with respect to the circumferential direction U and which are therefore oriented substantially in the circumferential direction U of the pneumatic vehicle tire.

The second belt ply 17, arranged in the radial direction R between first belt ply 14 and the lower of the two working plies 13, extends in the circumferential direction U over the entire circumference of the pneumatic vehicle tire and in the axial direction A of the pneumatic vehicle tire from the left-hand tire shoulder to the right-hand tire shoulder. The belt ply 17 is formed from a ply of filiform parallel strength members 27 which are embedded in rubber and which extend substantially rectilinearly over the entire axial width h of the belt ply 17 and which enclose an angle of inclination ε with respect to the circumferential direction U, where 40°≦ε≦75°, for example where ε=50°. The strength members 27 of the second belt ply 17, in one embodiment, are—as illustrated in FIG. 2—oriented with the same axial direction of inclination, as viewed along the extent in the circumferential direction U of the tire, as the strength members 23 of the third belt ply 13, and thus with an opposite axial direction of inclination in relation to the strength members 25 of the fourth belt ply 15.

All four belt plies 14, 17, 13 and 15 extend to both axial sides, in each case as far as a position in the respective tire shoulder. The belt ply 17 is, at least over a part of its axial extent, in direct contact with the third belt ply (lower working ply) 13 arranged thereabove.

The first belt ply (0°-ply) 14 extends in the axial direction A over an axial width b, the third belt ply (lower working ply) 13 extends in the axial direction A over an axial width a, and the fourth belt ply (upper working ply) 15 extends in the axial direction A over an axial width c in the tire. The second belt ply 17 extends in the axial direction A over an axial width h in the tire. The extent widths a, c, b and h are in this case selected to be a>c>h≧b. In this context, the third belt ply 13 extends to both axial sides of the first belt ply 14 by an axial extent length e beyond the axial position of the respective belt edge of the first belt ply 14. Likewise, the fourth belt ply 15 extends in both axial directions in each case by an axial extent length d beyond the axial position of the respective belt edge of the first belt ply 14. For the extent lengths e and d of this projecting length, the following applies: e>d. Here, the dimension d is configured to be d≧10 mm. In the exemplary embodiment, the dimension e is configured to be e≦60 mm.

The belt ply 17 extends over the entire axial extent of the first belt ply 14 in direct contact with the first belt ply 14, and ends in the axial direction A with its two belt ply edges in each case at an axial position between the axial position of the closest belt ply edge of the first belt ply 14 and the axial position of the closest belt ply edge of the radially outer working ply 15, at an axial distance k from the belt ply edge of the first belt ply 14, where k<d<e and where k≧0 mm.

In the exemplary embodiment shown, the following values are selected: h>b and k>0 mm.

The strength members 27 are steel cords of known type, for example of “1+5” type, “3+6” type, “3+8” type or “3+9” type.

The strength members 23 and 25 of the two working plies 13 and 15 are extensible steel cords of known type which, under tensile load, exhibit a breaking force F of F>2500N and, at 10% of the breaking force, an elongation D of D≧0.2%—for example where 0.28%≦D≦0.32%. The elongation D of the strength members is in this case the elongation determined, in the case of the vulcanized tire, on the strength member extracted from the ply. The measurement of the elongation is performed on strength members which have been removed over their full length from the complete vulcanized tire. For the measurement, the strength member has rubber residues removed from it such that the strength member with the amount of rubber remaining thereon has a diameter no greater than 1.5 times the maximum outer diameter of the non-rubberized strength member. The determination of the elongation is performed in accordance with ASTM D 2969-04.

The strength members 23 and 25 are for example steel cords of “3+8×0.35HT” type, with a breaking force F of approximately 3000 N and with an elongation D of D>0.2% at 10% of the breaking force.

In one embodiment, the strength members 24 are steel cords of known type. In another embodiment, the strength members 24 are steel cords which, at 10% of the breaking force, exhibit an elongation D of D≧0.2%—for example of D=0.5%. In one embodiment, the strength members 24 are steel cords which, at 10% of the breaking force, exhibit an elongation D of D≧1%—for example of D=1.3%.

The strength members 24 are for example steel cords of “3×7 HEHT” type.

In one exemplary embodiment, the following values are selected: β=3°, α=18°, γ=18°, ε=50°, d=11 mm, k=8 mm and e=15 mm.

In an alternative embodiment (not illustrated) in relation to the above embodiments, the angle of inclination α of the strength members 23 of the inner working ply 13 is in each case greater than the angle of inclination γ of the strength members 25 of the outer working ply 15.

In an alternative embodiment (not illustrated) in relation to the above embodiments, the angle of inclination α of the strength members 23 of the inner working ply 13 is in each case smaller than the angle of inclination γ of the strength members 25 of the outer working ply 15.

FIG. 3 and FIG. 4 show a further alternative embodiment in which, in addition to the belt plies 14, 17, 13 and 15 illustrated in FIG. 1 and FIG. 2, the belt 9 is formed with an additional, fifth belt ply 16 on the radially inner side of the belt ply 14, in between belt ply 14 and carcass 5, which fifth belt ply extends in the circumferential direction U over the entire circumference of the pneumatic vehicle tire and in the axial direction A of the pneumatic vehicle tire from the left-hand tire shoulder to the right-hand tire shoulder. The belt ply 16 is formed from a ply of filiform parallel strength members 26 which are embedded in rubber and which extend substantially rectilinearly over the entire axial width f of the belt ply 16 and which enclose an angle of inclination ε with respect to the circumferential direction U, where 40°≦δ≦75°, for example where δ=50°. The belt ply 16 extends, over the entire axial extent of the belt ply 14, in direct contact with the belt ply 14, and ends in the axial direction A with its two belt ply edges in each case at an axial position between the axial position of the closest belt ply edge of the first belt ply 14 and the axial position of the closest belt ply edge of the fourth belt ply (radially outer working ply) 15, at an axial distance g from the belt ply edge of the first belt ply 14, where g<d. The width f is the dimension of the axial extent of the fifth belt ply 16, where b<f and where f<a. In the exemplary embodiment shown, the following is selected: b<f<c<a.

In a further exemplary embodiment illustrated in FIGS. 3 and 4, the embodiment is additionally selected to be such that the following apply: f<h and g<k.

The strength members 26 of the fifth belt ply 16 are oriented—as illustrated in FIG. 4—with an opposite axial direction of inclination, as viewed along the extent in the circumferential direction U of the tire, in relation to the strength members 27 of the second belt ply 17.

The strength members 26 are steel cords of known type, for example of “1+5” type, “3+6” type, “3+8” type or “3+9” type.

In the exemplary embodiments mentioned above in conjunction with FIGS. 1 to 4, the strength members 27 and the strength members 26 are steel cords. In another embodiment which is not illustrated, the strength members 26 are hybrid cords of known type which are suitable for use in utility vehicle tires, in the case of which filaments or threads are produced from different materials, such as for example steel, polyamide, glass fiber, polyester or aramide. In another embodiment which is not illustrated, the strength members 27 are hybrid cords of known type which are suitable for use in utility vehicle tires, in the case of which filaments or threads are produced from different materials, such as for example steel, polyamide, glass fiber, polyester or aramide.

In another embodiment which is not illustrated, the strength members 23 and/or the strength members 24 and/or strength members 25 are also hybrid cords of known type which are suitable for use in utility vehicle tires, in the case of which filaments or threads are produced from different materials, such as for example steel, polyamide, glass fiber, polyester or aramide.

FIG. 4 shows an exemplary embodiment of the second belt ply 17 and of the third belt ply 13, in the case of which the strength members 27 of the second belt ply 17 and the strength members 23 of the third belt ply are oriented with an opposite axial direction of inclination as viewed along the extent in the circumferential direction U of the tyre.

In another embodiment, as illustrated by way of example in FIG. 2, the strength members 27 of the second belt ply 17 and the strength members 23 of the third belt ply are oriented with the same axial direction of inclination as viewed along the extent in the circumferential direction U of the tyre.

The angles α, β, γ, δ, ε form in each case at least the angle of inclination of the respective strength member as determined at the position of the equatorial plane of the tyre.

### LIST OF REFERENCE NUMERALS

(Part of the Description)

1 Bead region

2 Side wall

3 Crown region (top region)

4 Bead core

5 Carcass

6 Apex (bead filler)

7 Carcass turn-over

8 Bead reinforcing strip

9 Belt

10 Profiled tread

11 Side wall rubber strip

12 Inner layer

13 Belt ply (working ply)

14 Belt ply (zero-degree ply)

15 Belt ply (working ply)

16 Belt ply

17 Belt ply

23 Strength member

24 Strength member

25 Strength member

26 Strength member

27 Strength member

1.-13. (canceled)

14. A pneumatic vehicle tire comprising
a carcass;
a belt which is constructed radially outside the carcass; and,
a profiled tread which is constructed on the belt radially outside the belt;
wherein the belt is formed from at least four belt plies arranged lying one on top of one another from the radial inside to the radial outside, wherein a first belt ply, which is arranged furthest to the inside in radial direction R, is formed with parallel strength members embedded in rubber, wherein a second belt ply, arranged on the first belt ply, is formed with parallel strength members embedded in rubber, wherein a third belt ply, arranged on the second belt ply, is formed with parallel strength members embedded in rubber, wherein a fourth belt ply, arranged on the third belt ply, is formed with parallel strength members embedded in rubber;
wherein the third belt ply and the fourth belt ply are working plies, in which the strength members of the third belt ply enclose, in terms of their orientation, an angle α with the circumferential direction U, where 10°≦α≦45°, and the strength members of the fourth belt ply each enclose, in terms of their orientation, an angle γ with the circumferential direction U, where 10°≦γ≦45°, wherein, as viewed in the circumferential direction U of the vehicle tire, the strength members of the third belt ply have an opposite axial direction of inclination in relation to the strength members of the fourth belt ply; and,
wherein the strength members of the first belt ply enclose, in terms of their orientation, an angle β with the circumferential direction U, where 0°≦β≦5°, and the strength members of the second belt ply enclose, in terms of their orientation, an angle ε with the circumferential direction U, where 40°≦ε≦75°.

15. The pneumatic vehicle tire as claimed in claim 14, wherein, as viewed in the circumferential direction U, the strength members of the third belt ply and the strength members of the second belt ply have the same axial direction of inclination.

16. The pneumatic vehicle tire as claimed in claim 14, wherein the third belt ply is formed so as to be larger, in terms of its axial extent in the pneumatic vehicle tire, than all other belt plies of the belt.

17. The pneumatic vehicle tire as claimed in claim 14, wherein the first belt ply is formed so as to be smaller, in terms of its axial extent in the pneumatic vehicle tire, than the third and the fourth belt plies and smaller than or equal to the axial extent of the second belt ply of the belt.

18. The pneumatic vehicle tire as claimed in claim 14, wherein radially inside the first belt ply, there is arranged a fifth belt ply with parallel strength members embedded in rubber, which strength members, in terms of their orientation, enclose an angle δ with the circumferential direction U of the pneumatic vehicle tire, where 40°≦δ≦75°—in particular where δ=50°—and wherein, as viewed in the circumferential direction U of the vehicle tire, the strength members of the fifth belt ply have an opposite axial direction of inclination relative to the strength members of the second belt ply.

19. The pneumatic vehicle tire as claimed in claim 18, wherein, as viewed in the circumferential direction U of the vehicle tire, the strength members of the fifth belt ply have the same axial direction of inclination relative to the strength members of the third belt ply.

20. The pneumatic vehicle tire as claimed in claim 18, wherein the fifth belt ply is formed so as to be smaller, in terms of its axial extent in the pneumatic vehicle tire, than the third belt ply and larger than or equal to the width of the first belt ply.

21. The pneumatic vehicle tire as claimed in claim 14, wherein the strength members of the third belt ply and the strength members of the fourth belt ply are steel cords.

22. The pneumatic vehicle tire as claimed in claim 14, wherein the strength members of the third belt ply and the fourth belt ply are designed to be extensible, with an elongation D of D≧0.2% at 10% of the breaking force.

23. The pneumatic vehicle tire as claimed in claim 14, wherein the strength members of the first belt ply are strength members composed of steel.

24. The pneumatic vehicle tire as claimed in claim 14, wherein the strength members of the first belt ply are steel cords which, at 10% of the breaking force, exhibit an elongation D of D≧0.2%—in particular of D≧1%.

25. The pneumatic vehicle tire as claimed in claim 14, wherein the strength members of the second belt ply are steel cords.

26. The pneumatic vehicle tire as claimed in claim 18, wherein the strength members of the fifth belt ply are steel cords.

27. The pneumatic vehicle tire as claimed in claim 14, wherein the tire is a utility vehicle tire.

28. A pneumatic vehicle tire comprising
a carcass;
a belt which is constructed radially outside the carcass; and,
a profiled tread which is constructed on the belt radially outside the belt;
wherein the belt is formed from at least four belt plies arranged lying one on top of one another from the radial inside to the radial outside, wherein a first belt ply, which is arranged furthest to the inside in radial direction R, is formed with parallel strength members embedded in rubber, wherein a second belt ply, arranged on the first belt ply, is formed with parallel strength members embedded in rubber, wherein a third belt ply, arranged on the second belt ply, is formed with parallel strength members embedded in rubber;
wherein the strength members of the first belt ply enclose, in terms of their orientation, an angle β with the circumferential direction U, where 0°≦β≦5°, and the strength members of the second belt ply enclose, in terms of their orientation, an angle ε with the circumferential direction U, where 40°≦ε≦75°; and,
wherein, as viewed in the circumferential direction U, the strength members of the third belt ply and the strength members of the second belt ply have the same axial direction of inclination.

29. The pneumatic vehicle tire as claimed in claim 28, further comprising a fourth belt ply, arranged on the third belt ply, and formed with parallel strength members embedded in rubber, wherein the third belt ply and the fourth belt ply are working plies, in which the strength members of the third belt ply enclose, in terms of their orientation, an angle α with the circumferential direction U, where 10°≦α≦45°, and the strength members of the fourth belt ply each enclose, in terms of their orientation, an angle γ with the circumferential direction U, where 10°≦γ≦45°, and wherein, as viewed in the circumferential direction U of the vehicle tire, the strength members of the third belt ply have an opposite axial direction of inclination in relation to the strength members of the fourth belt ply.

30. The pneumatic vehicle tire as claimed in claim 28, wherein radially inside the first belt ply, there is arranged a fifth belt ply with parallel strength members embedded in rubber, which strength members, in terms of their orientation, enclose an angle δ with the circumferential direction U of the pneumatic vehicle tire, where 40°≦δ≦75°—in particular where δ=50°—and wherein, as viewed in the circumferential direction U of the vehicle tire, the strength members of the fifth belt ply have an opposite axial direction of inclination relative to the strength members of the second belt ply.

31. The pneumatic vehicle tire as claimed in claim 30, wherein the strength members of the fifth belt ply are steel cords.

32. The pneumatic vehicle tire as claimed in claim 30, wherein the fifth belt ply is formed so as to be smaller, in terms of its axial extent in the pneumatic vehicle tire, than the third belt ply and larger than or equal to the width of the first belt ply.

33. A pneumatic vehicle tire comprising
a carcass;
a belt which is constructed radially outside the carcass; and,
a profiled tread which is constructed on the belt radially outside the belt;
wherein the belt is formed from at least five belt plies arranged lying one on top of one another from the radial inside to the radial outside, wherein a first belt ply, which is arranged furthest to the inside in radial direction R, is formed with parallel strength members embedded in rubber, wherein a second belt ply, arranged on the first belt ply, is formed with parallel strength members embedded in rubber, wherein a third belt ply, arranged on the second belt ply, is formed with parallel strength members embedded in rubber, wherein a fourth belt ply, arranged on the third belt ply, is formed with parallel strength members embedded in rubber; and wherein radially inside the first belt ply, there is arranged a fifth belt; and,
wherein the third belt ply and the fourth belt ply are working plies, in which the strength members of the third belt ply enclose, in terms of their orientation, an angle α with the circumferential direction U, where 10°≦α≦45°, and the strength members of the fourth belt ply each enclose, in terms of their orientation, an angle γ with the circumferential direction U, where 10°≦γ≦45°, wherein, as viewed in the circumferential direction U of the vehicle tire, the strength members of the third belt ply have an opposite axial direction of inclination in relation to the strength members of the fourth belt ply.
